(19) United States
(12) Patent Application Publication
(10) Pub. No.: US 2015/0056859 A1
(43) Pub. Date: Feb. 26, 2015

(54) CONNECTOR

(71) Applicant: JAPAN AVIATION ELECTRONICS INDUSTRY, LIMITED, TOKYO (JP)

(72) Inventors: Masao HIGUCHI, Tokyo (JP); Tadashi ISHIWA, Tokyo (JP); Masayoshi NITTA, Tokyo (JP)

(73) Assignee: JAPAN AVIATION ELECTRONICS INDUSTRY, LIMITED, Tokyo (JP)

(21) Appl. No.: 14/149,038

(22) Filed: Jan. 7, 2014

(30) Foreign Application Priority Data
Aug. 23, 2013 (JP) 2013-173348

(51) Int. Cl. H01R 13/648

(52) U.S. Cl. CPC H01R 13/648
USPC 439/607.41

(57) ABSTRACT

In a connector that includes a board connector mounted on a board and a cable connector attached to ends of both a shielded cable and a non-shielded cable and connected to the board connector, the cable connector includes contacts connected respectively to the core wires of the shielded cable and the non-shielded cable and a shield shell that surrounds only the contacts connected to the core wires of the shielded cable, and the board connector includes board contacts connected respectively to the contacts of the cable connector and a shield shell that surrounds only the board contacts connected to the contacts surrounded by the shield shell of the cable connector. The connector properly shields the contacts connected to the core wires of the shielded cable in both of the mutually connected connectors and makes it easy to perform impedance matching.

### BACKGROUND OF THE INVENTION

1. Field of the Invention

The present invention relates to a connector for connecting both a shielded cable and a non-shielded cable.

2. Description of the Related Art

FIGS. 1A and 1B show the structure of an example of the conventional connector of the same type disclosed in Japanese Patent Application Laid Open No. H04-345778 (issued on Dec. 1, 1992). FIG. 1A shows a terminal housing with a shielded cable and a non-shielded cable attached. FIG. 1B shows a connector housing into which the terminal housing is inserted.

A terminal housing 1 includes a shielded terminal 3 for a shielded cable 2 and a non-shielded terminal 5 for a non-shielded cable 4. The shielded terminal 3 is formed by a core-wire terminal 3a covered by an external conductor terminal 3c, with an insulating material 3b placed between them. The core-wire terminal 3a has a contact part 3d, and the base part is secured to and electrically connected to a core wire 2a of the shielded cable 2. The external conductor terminal 3c has a contact part 3e formed at its end, and the base part is secured to and electrically connected to an external conductor 2b of the shielded cable 2.

The non-shielded terminal 5 to which the non-shielded cable 4 is attached is similar to the core-wire terminal 3a for the shielded terminal 3, and has a contact part 5a.

The shielded terminal 3 and the non-shielded terminal 5 are respectively inserted into a shielded-terminal insertion hole 6 and a non-shielded-terminal insertion hole 7 in the terminal housing 1. The terminal housing 1 has an engaging piece 8 at the top thereof, and the engaging piece 8 has an engaging projection part 8a.

A connector housing 11 includes a terminal mounting hole 12 and lead-out terminals 13, 14, and 15. The lead-out terminals 13 and 15 have a bar shape and project into the terminal mounting hole 12 from the back of the connector housing 11. The lead-out terminal 14 has a plate shape and is disposed along the inner face of back of the terminal mounting hole 12. The lead-out terminal 14 has a hole 14a which lets the lead-out terminal 13 pass through it without being in contact with it, and the back face is connected to a lead 14b. The connector housing 11 has an engaging hole 16 at the top thereof, and an engaging indentation 16a is formed in the engaging hole 16.

The terminal housing 1 is inserted into the terminal mounting hole 12 of the connector housing 11. The engaging piece 8 of the terminal housing 1 is inserted into the engaging hole 16 of the connector housing 11, and the engaging projection part 8a of the engaging piece 8 is engaged with the engaging indentation 16a in the engaging hole 16. The lead-out terminal 13 of the connector housing 11 comes into contact with the contact part 3d of the core-wire terminal 3a in the terminal housing 1, and the lead-out terminal 14 is held in contact with the contact part 3e of the external conductor terminal 3c. The lead-out terminal 15 is held in contact with the contact part 5a of the non-shielded terminal 5.

The connector illustrated in FIGS. 1A and 1B serves both the shielded cable 2 and the non-shielded cable 4 as described above and allows both the shielded cable 2 and the non-shielded cable 4 to be attached or detached as an integrated unit.

In the terminal housing 1, the core-wire terminal 3a connected with the core wire 2a of the shielded cable 2 is surrounded and shielded by the external conductor terminal 3c. While the terminal housing 1 is inserted into the connector housing 11, a part projecting into the terminal mounting hole 12, of the lead-out terminal 13 of the connector housing 11 in contact with the core-wire terminal 3a, is also surrounded by the external conductor terminal 3c and is therefore shielded. However, a part of the lead-out terminal 13, including an L-shaped part projecting from the back of the connector housing 11, is not shielded at all, causing impedance mismatching. If a high-speed (high-frequency) signal is transmitted, deterioration of the transmission characteristics is unavoidable.

### SUMMARY OF THE INVENTION

It is an object of the present invention to provide a connector that connects both a shielded cable and a non-shielded cable, the connector having two types of mutually connected connectors that respectively shield the contacts connected to the core wire of the shielded cable, making it easy to perform impedance matching and consequently providing excellent transmission characteristics.

A connector according to the present invention includes a board connector mounted on a board and a cable connector attached to ends of both a shielded cable and a non-shielded cable and connected to the board connector. The cable connector includes contacts connected respectively to the core wires of the shielded cable and the non-shielded cable and a shield shell surrounding only the contacts connected to the core wires of the shielded cable. The board connector includes board contacts connected respectively to the contacts of the cable connector and a shield shell surrounding only the board contacts connected to the contacts surrounded by the shield shell.

In the connector according to the present invention, the contacts of the cable connector connected to the core wires of the shielded cable are surrounded and shielded by the shield shell, and the board contacts of the board connector connected to the contacts surrounded by the shield shell of the cable connector are surrounded and shielded by the shield shell of the board connector. Therefore, impedance matching can be performed easily, excellent transmission characteristics can be obtained, and a high-speed signal can be transmitted with low loss.

### BRIEF DESCRIPTION OF THE DRAWINGS

FIG. 1A is a sectional view showing the structure of one of two conventional connectors to be mutually connected.

FIG. 1B is a sectional view showing the structure of the other of the two conventional connectors to be mutually connected.

FIG. 2A is a front view of a cable connector of a connector according to a first embodiment of the present invention.

FIG. 2B is a side view of the cable connector shown in FIG. 2A.

FIG. 2C is a rear view of the cable connector shown in FIG. 2A.

FIG. 2D is a perspective view of the cable connector shown in FIG. 2A.

FIG. 2E is a perspective view of the cable connector shown in FIG. 2A.

FIG. 3 is a sectional view of the cable connector shown in FIG. 2A.

FIG. 4 is an exploded perspective view of the cable connector shown in FIG. 2A, viewed from the front.

FIG. 5 is an exploded perspective view of the cable connector shown in FIG. 2A, viewed from the back.

FIG. 6A is a front view of a board connector of the connector according to the first embodiment of the present invention.

FIG. 6B is a side view of the board connector shown in FIG. 6A.

FIG. 6C is a rear view of the board connector shown in FIG. 6A.

FIG. 6D is a perspective view of the board connector shown in FIG. 6A.

FIG. 6E is a perspective view of the board connector shown in FIG. 6A.

FIG. 6F is a sectional view of the board connector shown in FIG. 6A.

FIG. 7A is an exploded perspective view of the board connector shown in FIG. 6A, viewed obliquely from above.

FIG. 7B is an exploded perspective view of the board connector shown in FIG. 6A, viewed obliquely from below.

FIG. 8A is an exploded perspective view of the structure of the connector according to the first embodiment of the present invention, viewed obliquely from above.

FIG. 8B is an exploded perspective view of the structure of the connector according to the first embodiment of the present invention, viewed obliquely from below.

FIG. 9A is a plan view of a board shown in FIG. 8A with a board connector and a housing mounted on it.

FIG. 9B is a perspective view of the board shown in FIG. 8A with the board connector and the housing mounted on it.

FIG. 10A is a perspective view of a connected state of the connector according to the first embodiment of the present invention, viewed obliquely from above.

FIG. 10B is a perspective view of the connected state of the connector according to the first embodiment of the present invention, viewed obliquely from below.

FIG. 11 is a sectional view of the connected state of the connector shown in FIG. 10A.

FIG. 12 is a sectional perspective view of the structure of the connector according to the first embodiment of the present invention.

FIG. 13A is an exploded perspective view of the structure of a connector according to a second embodiment of the present invention, viewed obliquely from above.

FIG. 13B is an exploded perspective view of the structure of the connector according to the second embodiment of the present invention, viewed obliquely from below.

FIG. 14A is a plan view of a case shown in FIG. 13A with a board, a board connector, and a housing mounted on it.

FIG. 14B is a perspective view of the case shown in FIG. 13A with the board, the board connector, and the housing mounted on it.

FIG. 15A is a perspective view of a connected state of the connector according to the second embodiment of the present invention, viewed obliquely from above.

FIG. 15B is a perspective view of the connected state of the connector according to the second embodiment of the present invention, viewed obliquely from below.

FIG. 16 is a sectional view of the connected state of the connector shown in FIG. 15A.

FIG. 17 is a sectional perspective view of the structure of the connector according to the second embodiment of the present invention.

FIG. 18A is a plan view of a relay connector of a connector according to a third embodiment of the present invention.

FIG. 18B is a front view of the relay connector shown in FIG. 18A.

FIG. 18C is a bottom view of the relay connector shown in FIG. 18A.

FIG. 18D is a perspective view of the relay connector shown in FIG. 18A.

FIG. 18E is a perspective view of the relay connector shown in FIG. 18A.

FIG. 19 is a sectional view of the relay connector shown in FIG. 18A.

FIG. 20A is an exploded perspective view of the relay connector shown in FIG. 18A, viewed obliquely from above.

FIG. 20B is an exploded perspective view of the relay connector shown in FIG. 18A, viewed obliquely from below.

FIG. 21A is a front view of a contact assembly shown in FIG. 20A.

FIG. 21B is a side view of the contact assembly shown in FIG. 21A.

FIG. 21C is a rear view of the contact assembly shown in FIG. 21A.

FIG. 21D is a perspective view of the contact assembly shown in FIG. 21A.

FIG. 21E is a perspective view of the contact assembly shown in FIG. 21A.

FIG. 22A is an exploded perspective view of the contact assembly shown in FIG. 21A, viewed obliquely from above.

FIG. 22B is an exploded perspective view of the contact assembly shown in FIG. 21A, viewed obliquely from below.

FIG. 23A is a front view of a board connector in the connector according to the third embodiment of the present invention.

FIG. 23B is a side view of the board connector shown in FIG. 23A.

FIG. 23C is a rear view of the board connector shown in FIG. 23A.

FIG. 23D is a perspective view of the board connector shown in FIG. 23A.

FIG. 23E is a perspective view of the board connector shown in FIG. 23A.

FIG. 23F is a sectional view of the board connector shown in FIG. 23A.

FIG. 24A is an exploded perspective view of the board connector shown in FIG. 23A, viewed obliquely from above.

FIG. 24B is an exploded perspective view of the board connector shown in FIG. 23A, viewed obliquely from below.

FIG. 25A is an exploded perspective view of the structure of the connector according to the third embodiment of the present invention, viewed obliquely from above.

FIG. 25B is an exploded perspective view of the structure of the connector according to the third embodiment of the present invention, viewed obliquely from below.

FIG. 26A is a perspective view of a connected state of the connector according to the third embodiment of the present invention, viewed obliquely from above.

FIG. 26B is a perspective view of the connected state of the connector according to the third embodiment of the present invention, viewed obliquely from below.

FIG. 27 is a sectional view of the connected state of the connector shown in FIG. 26A.

FIG. 28 is a sectional perspective view of the structure of the connector according to the third embodiment of the present invention.

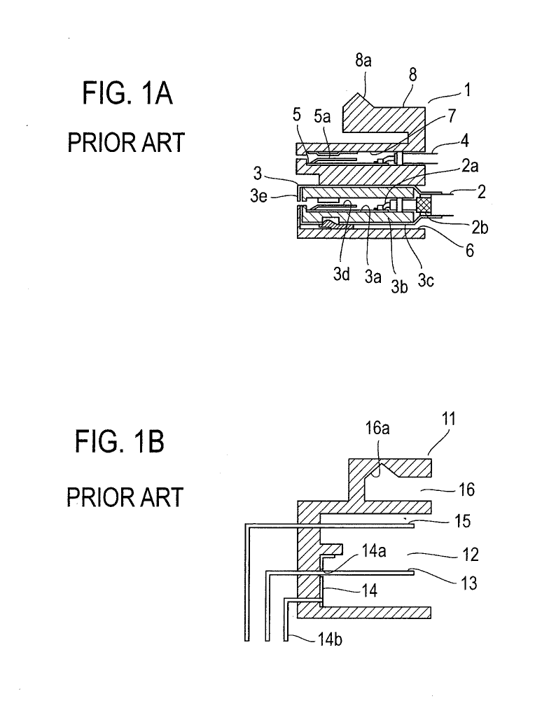

### DETAILED DESCRIPTION OF THE PREFERRED EMBODIMENTS

Embodiments of the present invention will be described next.

### First Embodiment

A connector for connecting both a shielded cable and a non-shielded cable in this embodiment includes a cable connector attached to ends of both the shielded cable and the non-shielded cable and a board connector mounted on a board.

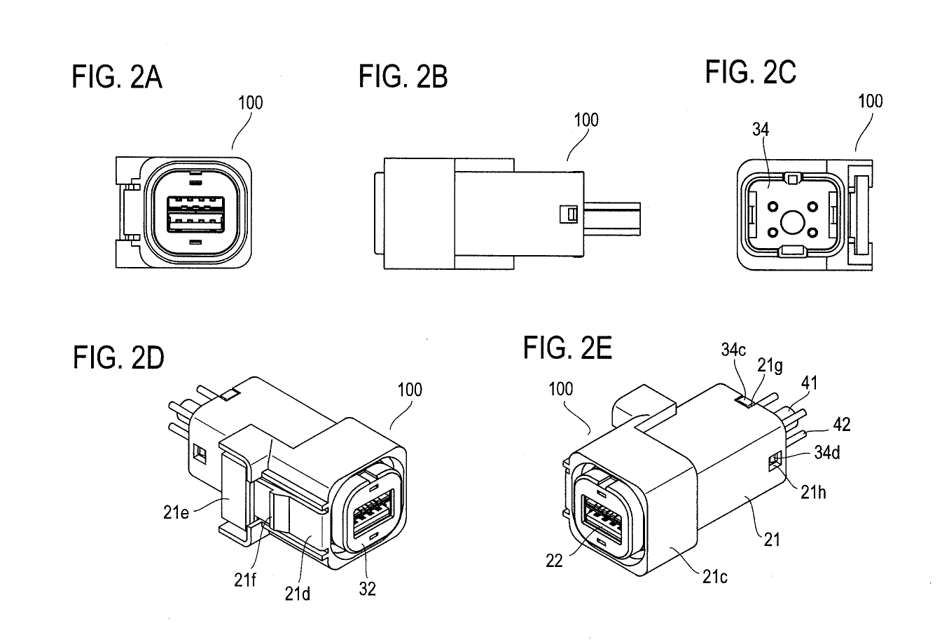

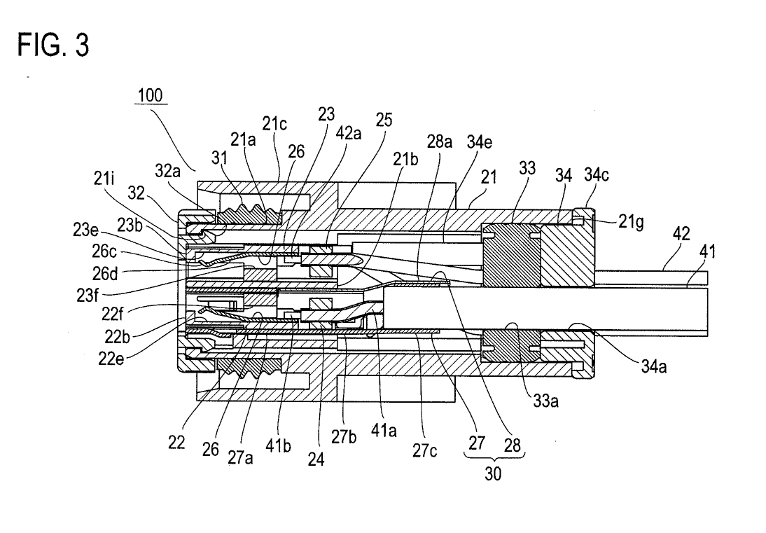

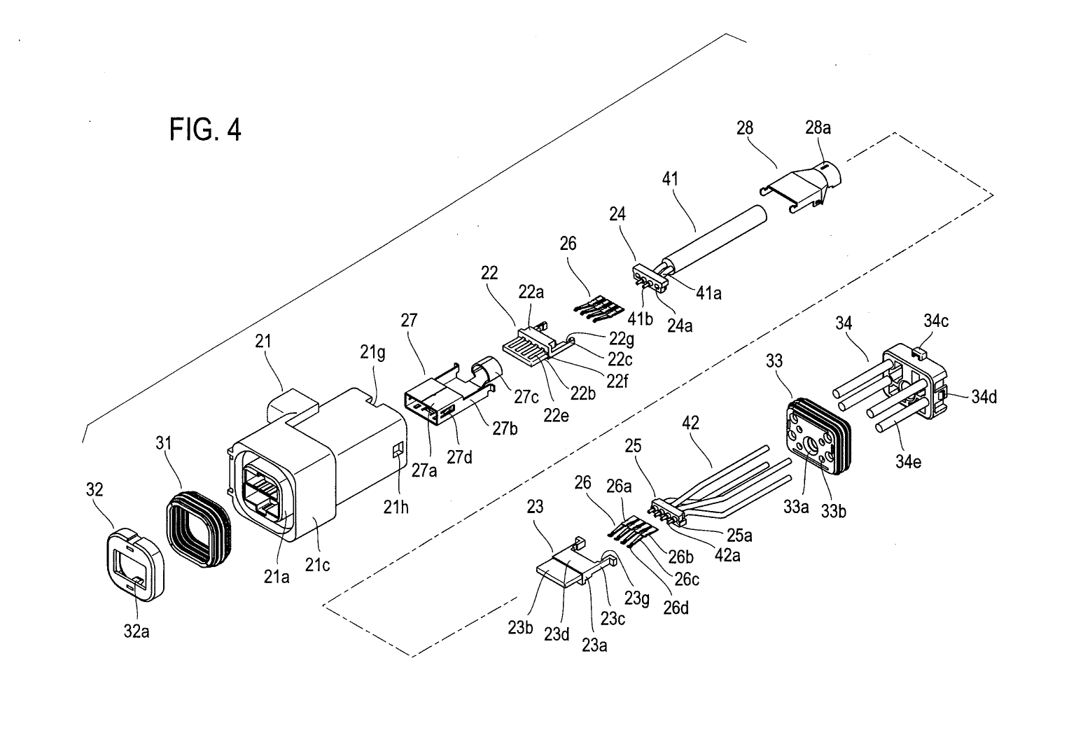

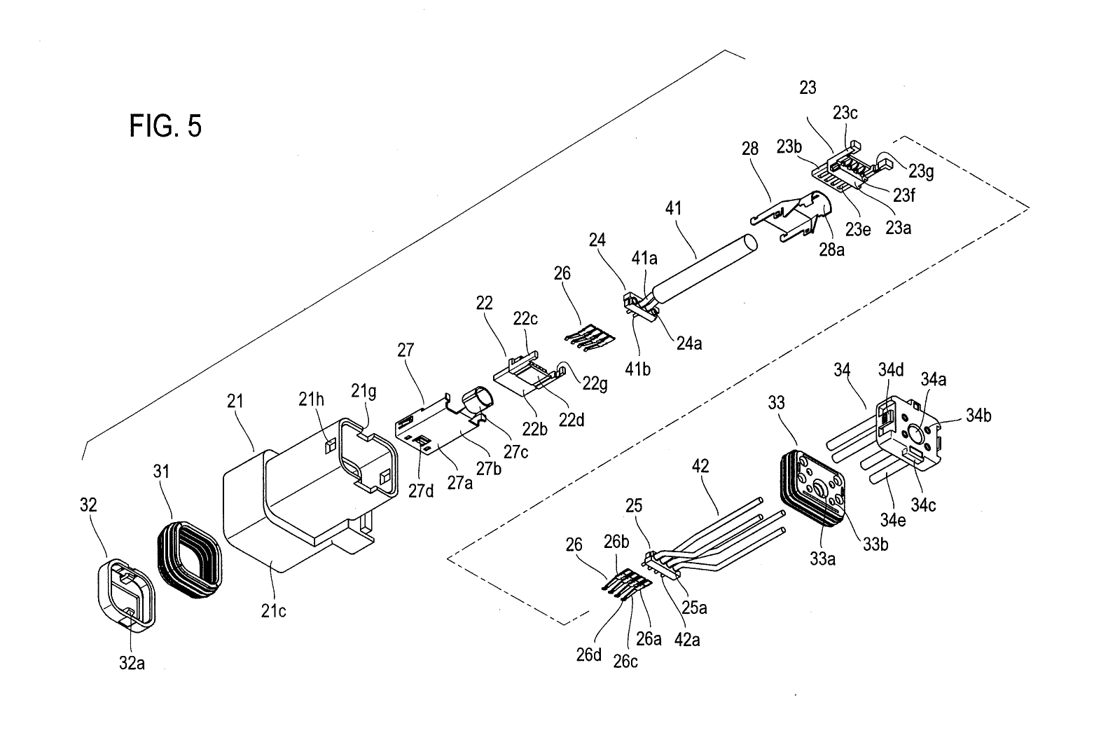

FIGS. 2A to 2E show the appearance of a cable connector 100, and FIG. 3 is a sectional view of the structure. FIGS. 4 and 5 are exploded views of the cable connector 100. As shown in FIGS. 4 and 5, the cable connector 100 includes an outer housing 21, inner housings 22 and 23, cable holders 24 and 25, contacts 26, a shell 27, a cover shell 28, a rubber seal 31, a front cap 32, a grommet 33, and a retainer 34. In FIGS. 4 and 5, reference numeral 41 denotes a shielded cable, and reference numeral 42 denotes a non-shielded cable (discrete wire).

The inner housings 22 and 23 hold the contacts 26 in line and are made of resin.

The inner housing 22 includes a base part 22a, a tongue piece 22b projecting from the base part 22a toward the front, a pair of arm parts 22c projecting from both ends in the width direction of the base part 22a toward the back, and a plate-like part 22d which connects the arm parts 22c on the side of the base part 22a. In the tongue piece 22b, four grooves 22e parallel to the projecting direction are formed in this embodiment. These grooves 22e extend respectively through holes 22f formed in the base part 22a toward the plate-like part 22d. The arm parts 22c each have an indentation 22g on their inner faces that face each other, near their ends.

The inner housing 23 has the same structure as the inner housing 22, including a base part 23a, a tongue piece 23b, a pair of arm parts 23c, and a plate-like part 23d and has four grooves 23e, four holes 23f, and a pair of indentations 23g.

The contacts 26 are made of strip-shaped metal plates. A press fitting part 26a in the middle part in the longitudinal direction of each contact 26 has projections 26b to be press-fitted on both sides in the width direction. The front side of the press fitting part 26a is bent and raised to make a movable section 26c, and a contact portion 26d is folded back into a circular shape at the tip of the movable section 26c.

Four contacts 26 are attached to each of the inner housings 22 and 23. The press fitting parts 26a of the contacts 26 are press-fitted respectively into the holes 22f and 23f of the inner housings 22 and 23, and the contacts 26 are respectively disposed in the grooves 22e and 23e.

Core wires of the shielded cable 41 are connected to the back ends of the contacts 26 press-fitted into the inner housing 22, and core wires of the non-shielded cables 42 are connected to the back ends of the contacts 26 press-fit into the inner housing 23.

In the grommet 33 and the retainer 34 disposed at the back end of the cable connector 100, holes 33a and 34a for inserting the shielded cable 41 and holes 33b and 34b for inserting the non-shielded cable 42 are formed, respectively. Four holes 33b and four holes 34b are formed for inserting the non-shielded cables 42. In this embodiment, one shielded cable 41 and four non-shielded cables 42 are attached.

The shielded cable 41 is passed through the hole 34a of the retainer 34 and the hole 33a of the grommet 33. The shielded cable 41 in this embodiment is a two-core cable having two signal wires 41a. These signal wires 41a are respectively passed through holes 24a arranged in the resin cable holder 24, having a block shape, and are positioned accordingly. Four holes 24a are formed in this embodiment, and the signal wires 41a are passed through two of the holes 24a disposed in inner positions.

The cable holder 24 holding the signal wires 41a is press-fitted between the pair of arm parts 22c of the inner housing 22 and is positioned and secured with its ends fitted into the indentations 22g of the pair of atm parts 22c. The core wires 41b of the two signal wires 41a are respectively connected by soldering them to the back ends of contacts 26 held in line by the inner housing 22.

A shell 27 is attached to the inner housing 22. The shell 27 is formed by bending a metal plate. The front half 27a has a rectangular tube shape surrounding the inner housing 22. The back half 27b has a rectangular tube shape with an open top. A crimping part 27c projecting from the back half 27b is formed at the back of the back half 27b.

The crimping part 27c of the shell 27 is not shown in detail in FIG. 3 but is crimped around the shield of the core wires of the shielded cable 41 with its jacket removed. A cover shell 28 is attached to the back half 27b of the shell 27.

The cover shell 28 is formed by bending a metal plate and covers the top of the back half 27b of the shell 27. The cover shell 28 has a crimping part 28a at the back, and the crimping part 28a is crimped around the crimping part 27c of the shell 27.

In this embodiment, the shell 27 and the cover shell 28 form a shield shell 30. The signal wires 41a drawn from the shielded cable 41 and the contacts 26 held in the inner housing 22 are surrounded at their full lengths by the shield shell 30 formed of the shell 27 and the cover shell 28, as shown in FIG. 3.

The four non-shielded cables 42 are passed through the holes 34b in the retainer 34 and the holes 33b in the grommet 33. The four non-shielded cables 42 are inserted into respective holes 25a in the cable holder 25, which has the same structure as the cable holder 24, and are positioned accordingly.

The cable holder 25 holding the four non-shielded cables 42 is press-fitted between the pair of arm parts 23c of the inner housing 23, and its ends are inserted into the indentations 23g in the pair of arm parts 23c to position the cable holder 25. The core wires 42a of the four non-shielded cables 42 are connected by soldering them to the back ends of the contacts 26 held in line by the inner housing 23.

The inner housing 23 and the inner housing 22 to which the shield shell 30 is attached are inserted into the outer housing 21 and are positioned in an insertion joint 21a in the front end of the outer housing 21.

The outer housing 21 forms the external shape of the cable connector 100, is made of resin, and has a rectangular tube shape with rounded corners and edges. In the front insertion joint 21a in the front end of the outer housing 21, spaces for holding the inner housing 23 and the inner housing 22 with the shield shell 30 attached thereto are formed by a partition wall 21b. The front ends of the inner housings 22 and 23 are adjacent to each other in the front end of the insertion joint 21a.

A tubular part 21c is disposed to surround the insertion joint 21a from the outside, leaving a given space around the insertion joint 21a. A fixed spring piece 21d is formed on the outer face of the tubular part 21c, extending from the front end toward the back end of the outer housing 21. The back end of the fixed spring piece 21d is a free end, and an operating element 21e that can be pressed with a finger is formed on the free end. A projection 21f is formed on the outer surface of the fixed spring piece 21d.

The grommet 33 and the retainer 34 are pressed into the back end of the outer housing 21 in that order. The grommet 33 is a waterproofing member made of rubber, and the grommet 33 closes off the back end of the outer housing 21.

The retainer 34 is disposed on the outside of the grommet 33. A pair of projections 34c formed in opposing positions on the periphery of the retainer 34 are fitted into a pair of notches 21g formed in the back end of the outer housing 21, and a pair of fixed spring pieces 34d formed in opposing positions on the periphery of the retainer 34 in a direction orthogonal to the direction in which the pair of projections 34c are facing are caught by a pair of windows 21h formed in the outer housing 21. In this way, the retainer 34 is secured to the back end of the outer housing 21. Four rod-shaped pieces 34e projecting from the inner face of the retainer 34 hold the inner housings 22 and 23 by pressing their ends against the back end faces of the inner housings 22 and 23.

The rubber seal 31 is attached around the insertion joint 21a of the outer housing 21. The rubber seal 31 is a waterproofing member and is held in the space between the insertion joint 21a and the tubular part 21c surrounding the insertion joint 21a. The front cap 32 is mounted to the front end of the insertion joint 21a to prevent the rubber seal 31 from falling out. A pair of fixed spring pieces 32a are provided on the inner face of the front cap 32. The fixed spring pieces 32a are hooked by stage parts 21i in the front end of the insertion joint 21a to secure the front cap 32 to the outer housing 21. The front cap 32 and the retainer 34 are made of resin.

The structure of the board connector connected to the cable connector 100 structured as described above will be described next.

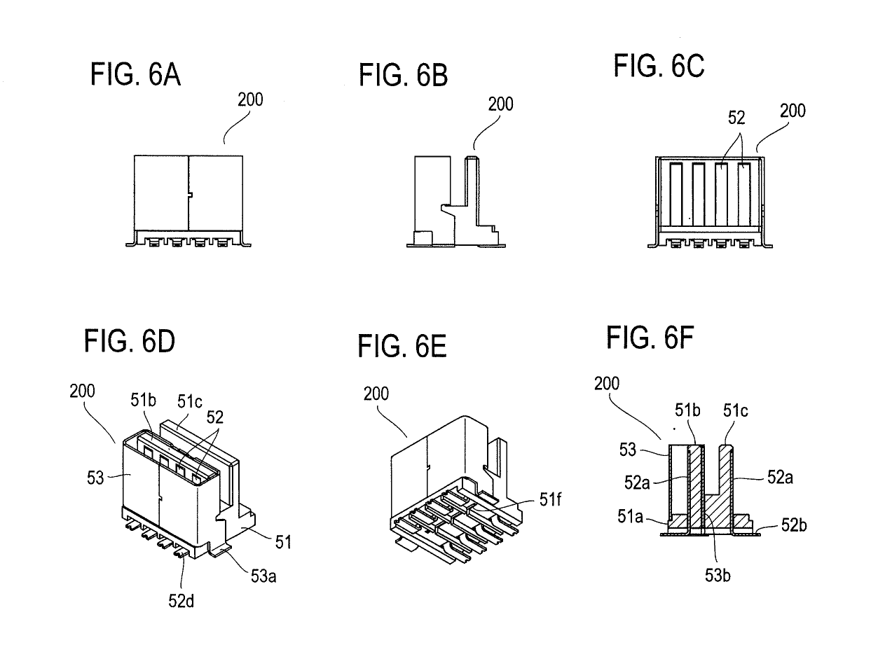

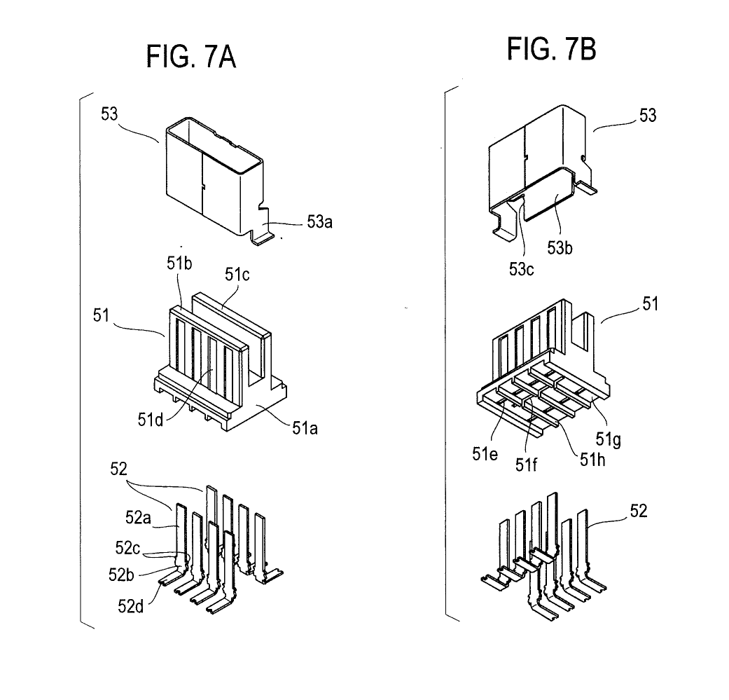

FIGS. 6A to 6F show the appearance of a board connector 200 and sectional views of the structure. FIGS. 7A and 7B are exploded views of the board connector 200. The board connector 200 includes a body 51, board contacts 52, and a shield shell 53.

The body 51 is made of resin and holds the board contacts 52 in line. The body 51 includes a base 51a and a pair of vertical plates 51b and 51c projecting from the base 51a. The outer faces of the pair of vertical plates 51b and 51c have grooves 51d formed in a direction parallel to the direction in which the vertical plates 51b and 51c project. The vertical plates 51b and 51c each have four grooves 51d.

Slits 51e are formed in the base 51a in line with the grooves 51d. The slits 51e have the same cross-sectional shape as the grooves 51d. A slit 51f is also formed in the base 51a on the extension of the inner face of the vertical plate 51b.

A recessed part 51g is formed in the lower face of the base 51a. Walls 51h are formed in the recessed part 51g and are disposed between adjacent slits 51e in the longitudinal direction of the slits 51e.

Each board contact 52 is a strip-shaped metal plate bent into an L shape. The base of a vertical part 52a, which forms one side of the L shape, is a press-fitting part 52b. The press-fitting part 52b has projections 52c to be press-fitted, projecting from both sides in the width direction.

The board contacts 52 are attached to the body 51 by press-fitting the press-fitting parts 52b into the slits 51e of the body 51, and the vertical parts 52a are disposed in the grooves 51d in the vertical plates 51b and 51 c. A total of eight board contacts 52 are attached to the body 51. The horizontal parts 52d, which form the other side of the L shape, of the board contacts 52 arranged on the vertical plates 51b and 51 c are disposed outward in the recessed part 51g of the base 51a with their tips projecting from the base 51a.

The shield shell 53 is formed by bending a metal plate and has a rectangular tube shape surrounding the vertical plate 51b of the body 51. A pair of foots 53a project from the opposing short sides at one end of the shield shell 53, and the ends of the foots 53a are bent outward. One long side at the same end of the shield shell 53 is a press-fitting part 53b to be press-fitted into the slit 51f in the body 51. The press-fitting part 53b has a width corresponding to the length of the slit 51f and also has projections 53c to be press-fitted, projecting from both sides in the width direction.

The press-fitting part 53b is press-fitted into the slit 51f of the body 51 to attach the shield shell 53 to the body 51 in such a manner that the vertical plate 51b is surrounded thereby. A face of the shield shell 53 facing the board contacts 52 arranged on the vertical plate 51b is separated from the board contacts 52. A given space is left between the shield shell 53 and the board contacts 52.

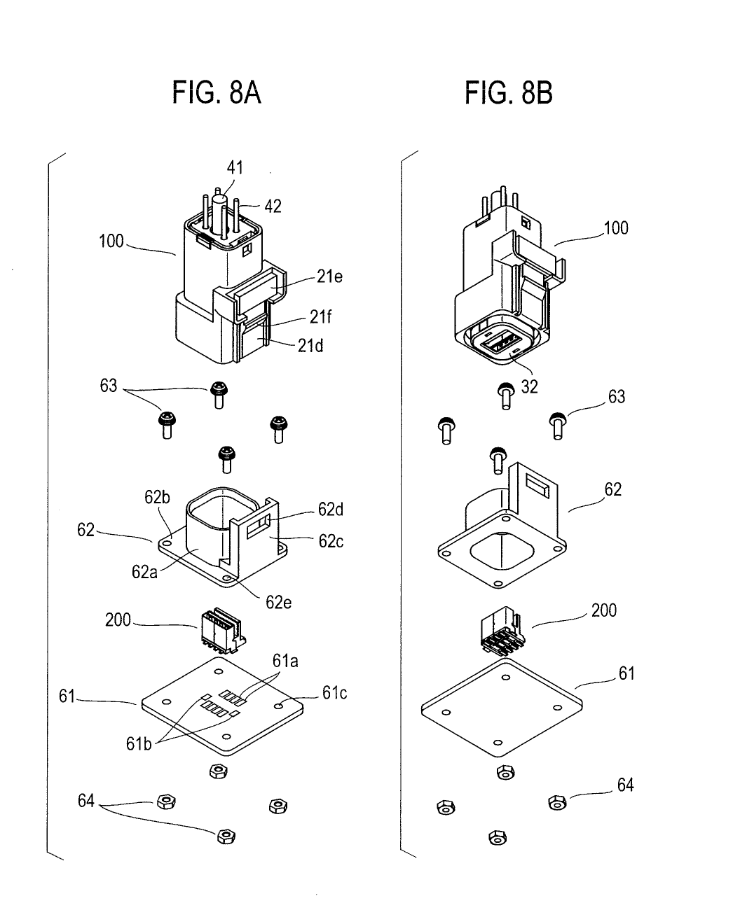

FIGS. 8A and 8B show the cable connector 100, the board connector 200, a board 61 on which the board connector 200 is mounted, and a housing 62 which is mounted on the board 61.

The board 61 has eight electrode patterns 61a to which the board contacts 52 of the board connector 200 are soldered respectively and two ground electrode patterns 61b to which the pair of foots 53a of the shield shell 53 of the board connector 200 are soldered respectively. The board connector 200 is surface-mounted onto the board 61 by reflow soldering.

The housing 62 is made of resin and includes a tubular part 62a, a rectangular flange 62b disposed on one end of the tubular part 62a, and a side wall part 62c provided upright on one side of the rectangular flange 62b in parallel with the tubular part 62a. The tubular part 62a has a rectangular tube shape with corners rounded to match the external shape of the insertion joint 21a of the cable connector 100. In the upper part of the side wall part 62c, a rectangular window 62d for catching the projection 21f on the cable connector 100 is formed.

The housing 62 is mounted on the board 61 to surround the board connector 200 mounted on the board 61. The housing 62 is secured with screws 63 and nuts 64. The flange 62b of the housing 62 and the board 61 have four holes 62e and four holes 61c, respectively. The housing 62 is secured to the board 61 by inserting the four screws 63 into the holes 62e and 61c and tightening the nuts 64.

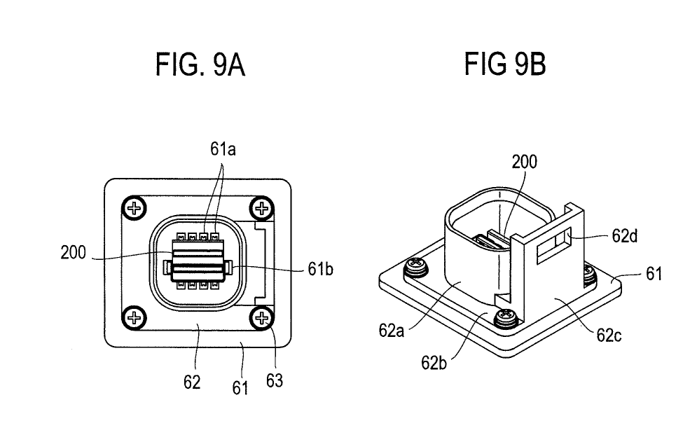

FIGS. 9A and 9B show the board 61 with the board connector 200 and the housing 62 mounted on it. The board connector 200 is placed at the center of the tubular part 62a of the housing 62.

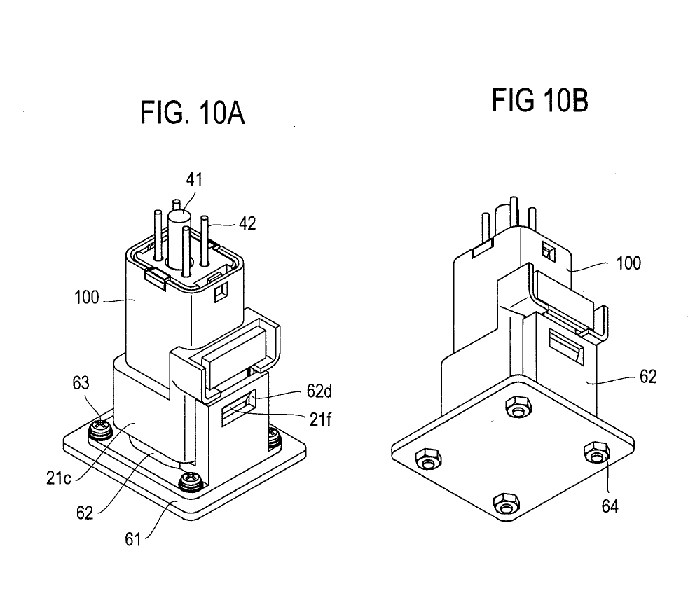

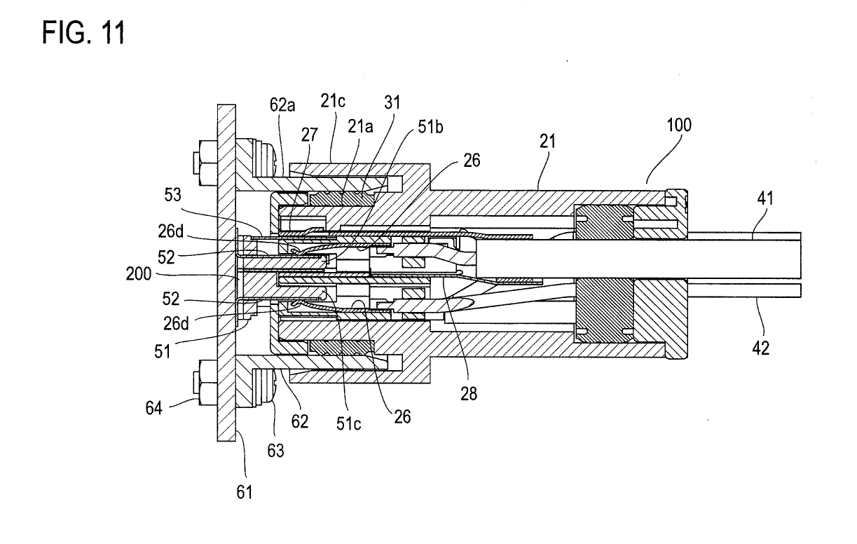

FIGS. 10A and 10B show the board connector 200 mounted on the board 61 with the cable connector 100 connected thereto. FIG. 11 shows a sectional view of the connected state.

The insertion joint 21a of the cable connector 100 is inserted into and coupled to the tubular part 62a of the housing 62. The projection 21f of the cable connector 100 is caught by the window 62d of the housing 62. The housing 62 guides the cable connector 100 toward the board connector 200 and also prevents the cable connector 100 from falling. The cable connector 100 can be uncoupled by pressing the operating element 21e of the cable connector 100 with a finger to release the projection 21f, and then the cable connector 100 can be pulled out.

When the cable connector 100 is connected to the board connector 200, the vertical plates 51b and 51c of the board connector 200 are inserted into the insertion joint 21a of the cable connector 100. The contact portions 26d of the eight contacts 26 of the cable connector 100 come into contact with the board contacts 52 arranged on the vertical plates 51b and 51c, respectively, and the eight contacts 26 of the cable connector 100 and the eight board contacts 52 of the board connector 200 are connected. The contacts 26 surrounded by the shield shell 30 of the cable connector 100 are connected to the board contacts 52 surrounded by the shield shell 53 of the board connector 200. The shield shell 53 of the board connector 200 is also inserted into the insertion joint 21a. The shield shell 53 and the shield shell 30 of the cable connector 100 are electrically connected to each other by a contact piece 27d formed by cutting and raising a part of one shell 27 constituting the shield shell 30, held in contact with the shield shell 53.

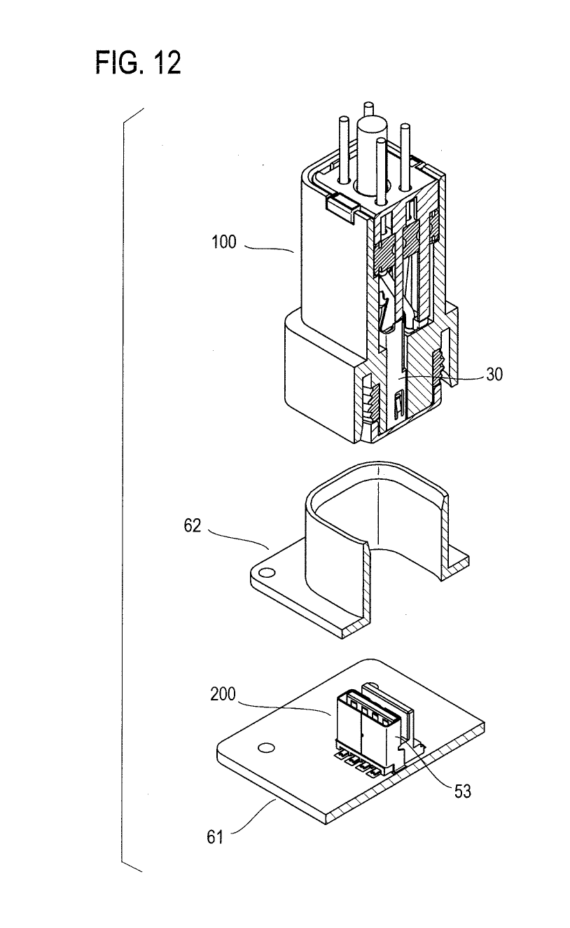

FIG. 12 is a sectional view showing the positional relationship between the shield shell 30 housed in the cable connector 100 and the shield shell 53 of the board connector 200, with the housing 62 and the shield shell 30 exposed.

In this embodiment, the contacts 26 of the cable connector 100 connected to the core wires 41b of the shielded cable 41 are surrounded and properly shielded by the shield shell 30, and the board contacts 52 of the board connector 200 connected to the contacts 26 surrounded by the shield shell 30 are also surrounded and properly shielded by the shield shell 53.

Second and third embodiments will be described next. Elements identical to elements in the first embodiment will be indicated by identical reference symbols, and a detailed description of those elements will be omitted.

### Second Embodiment

In the first embodiment, the housing 62 is attached to the board 61 on which the board connector 200 is mounted. In the second embodiment, the housing is attached to a case accommodating the board.

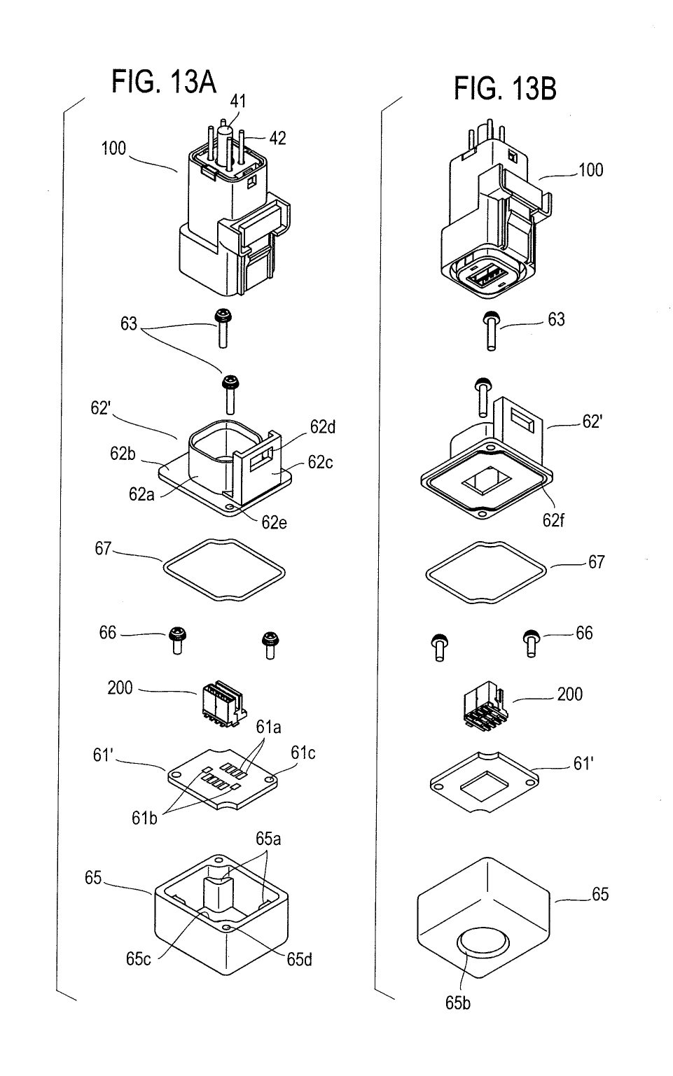

FIGS. 13A and 13B show the structure of the second embodiment. In FIGS. 13A and 13B, reference numeral 65 denotes a case accommodating a board 61′. The other parts disposed in the case 65 are not shown in the figure. The case 65 is the case of a camera, for example. The case 65 has a rectangular parallelepiped shape and has stage parts 65a formed in the four inner corners. The top of the case 65 is open. The case 65 has a circular window 65b formed in the bottom for a lens to be disposed inside.

The board connector 200 is surface-mounted on the board 61′ by reflow soldering, and the board 61′ with the board connector 200 mounted thereon is mounted to the case 65. The board 61′ is secured with two screws 66. The two screws 66 are inserted into two holes formed in the board 61′ and screwed into holes (hidden in FIG. 13A) formed in a pair of opposing stage parts 65a of the case 65 to secure the board 61′ to the case 65.

A housing 62′ is attached to the case 65 to close the top opening 65c of the case 65. The housing 62′ is secured with two screws 63. The two screws 63 are inserted into two holes 62e formed in the flange 62b of the housing 62′ and are screwed into holes 65d formed in the top face of the case 65. Then, the housing 62′ is secured to the case 65. An O ring 67 is placed between the top face of the case 65 and the flange 62b of the housing 62′. The flange 62b has a groove 62f on its bottom for positioning the O ring 67.

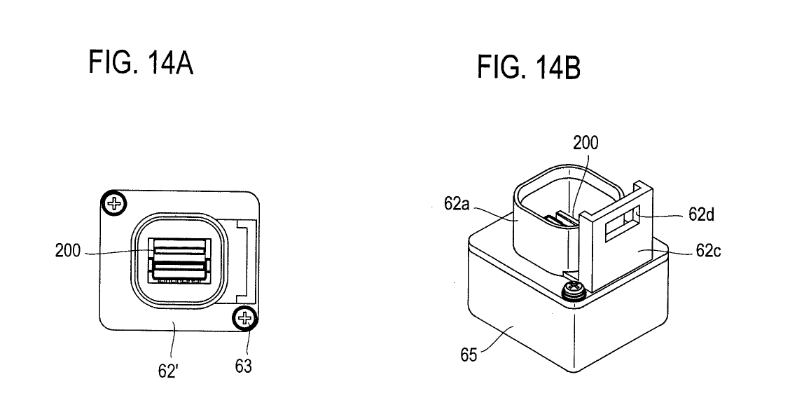

FIGS. 14A and 14B show that the board 61′ on which the board connector 200 is mounted and the housing 62′ are attached to the case 65. In this embodiment, the housing 62′ guides the cable connector 100 to the board connector 200, prevents the cable connector 100 from falling out, and also closes the case 65.

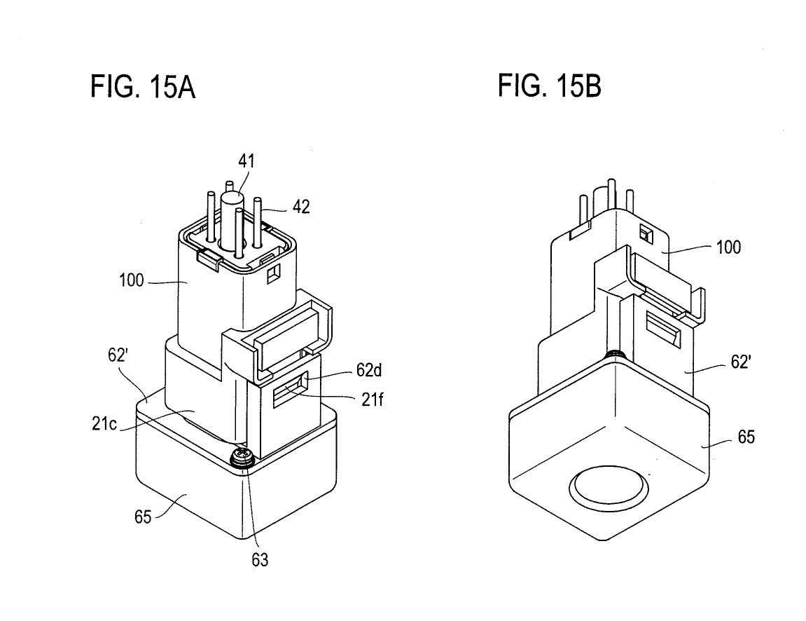

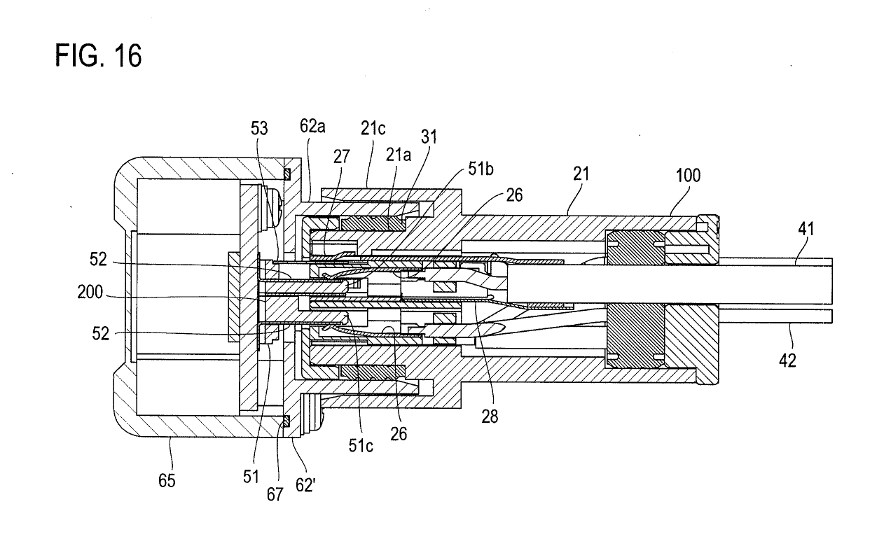

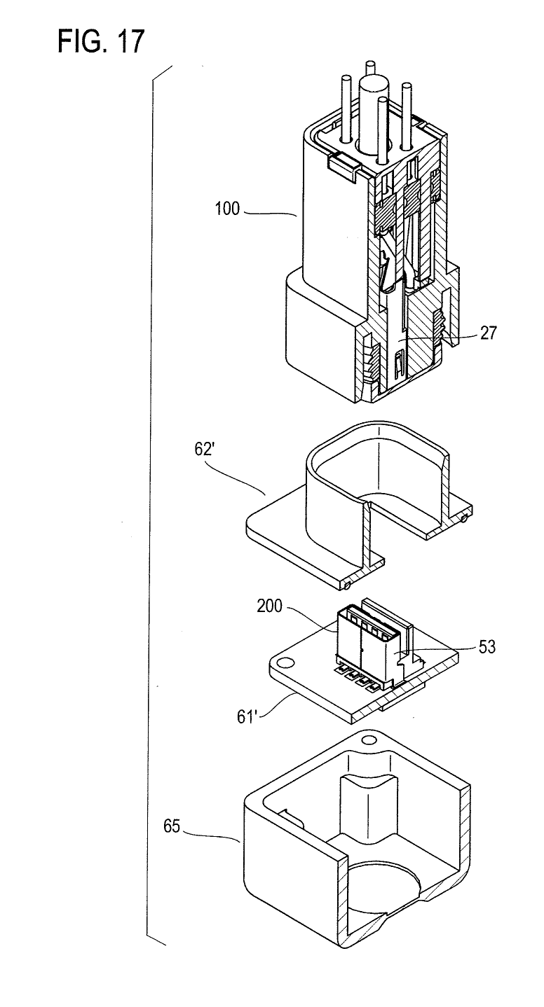

FIGS. 15A and 15B show the cable connector 100 connected to the board connector 200 mounted as shown in FIGS. 14A and 14B in the same manner as in the first embodiment. FIG. 16 is a sectional view of the connected state. FIG. 17 shows the same kind of sectional view as shown in FIG. 12 in the first embodiment. The other parts disposed in the case 65 are not shown in FIG. 16 either.

The cable connector 100 and the board connector 200 in this embodiment are the same as in the first embodiment, and the contacts 26 of the cable connector 100 connected to the core wires 41b of the shielded cable 41 and the board contacts 52 of the board connector 200 are properly shielded. The inside of the case 65 is provided with a waterproofing structure in this embodiment, in a state in which the cable connector 100 is connected to the board connector 200 as shown in FIGS. 15A, 15B, and 16; this state will be described below.

The back end of the cable connector 100 from which the shielded cable 41 and the non-shielded cable 42 are drawn is waterproofed by the grommet 33 as described earlier. The O ring 67 is held between the case 65 and the housing 62′ for waterproofing. In addition, since the rubber seal 31 is also attached around the insertion joint 21a of the cable connector 100, when the insertion joint 21a is inserted into and coupled to the tubular part 62a of the housing 62′, the rubber seal 31 is held between the tubular part 62a and the insertion joint 21a and provides waterproofing to that portion. Accordingly, when the cable connector 100 is connected to the board connector 200, the case 65 prevents liquid from entering.

### Third Embodiment

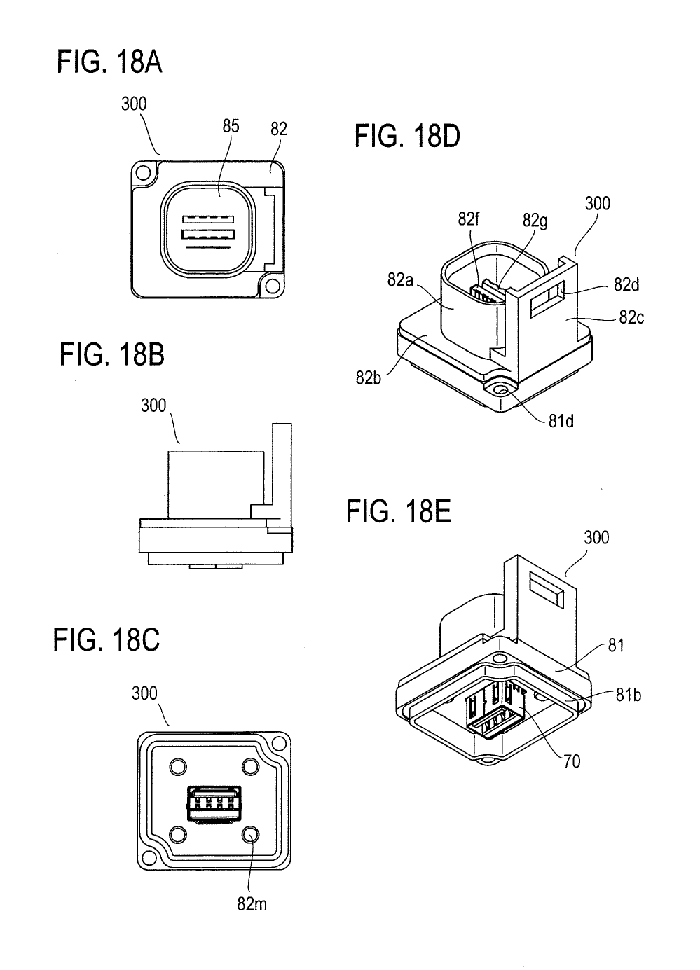

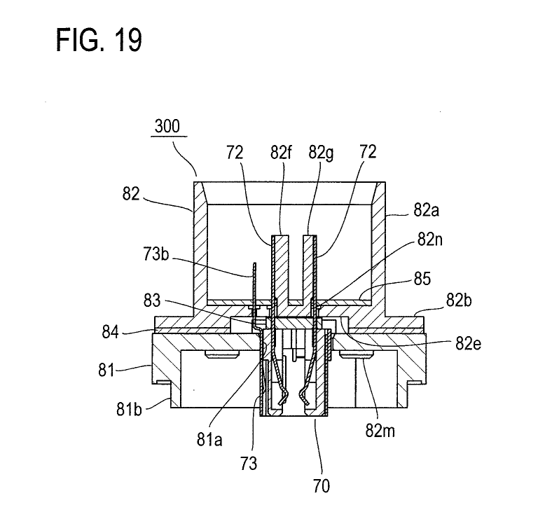

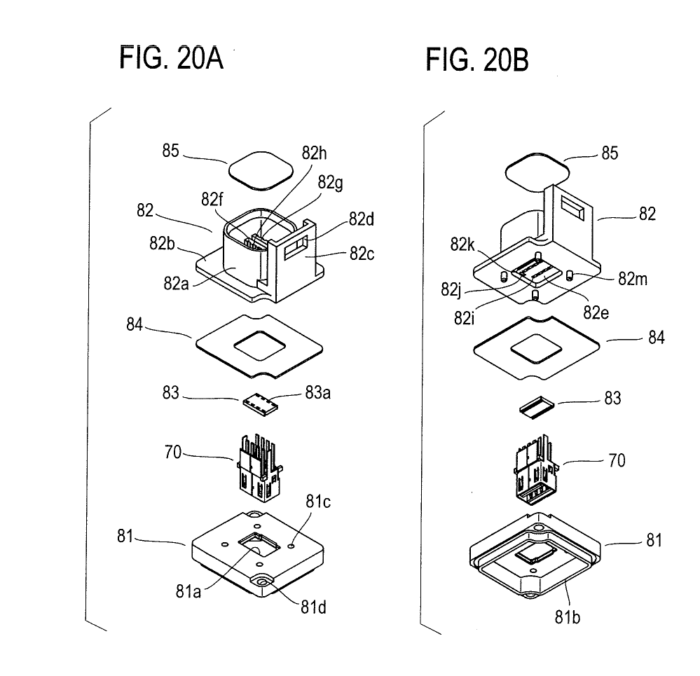

In a third embodiment, a cable connector and a board connector are connected through a relay connector. FIGS. 18A to 18E show the appearance of a relay connector 300, and FIG. 19 is a sectional view of the structure. FIGS. 20A and 20B are exploded views of the relay connector 300.

As shown in FIGS. 20A and 20B, the relay connector 300 includes a contact assembly 70, a rear case 81, a housing 82, an insulating plate 83, an adhesive 84, and a resin sealant 85. The adhesive 84 and the resin sealant 85 are schematically shown as elements in FIGS. 20A and 20B.

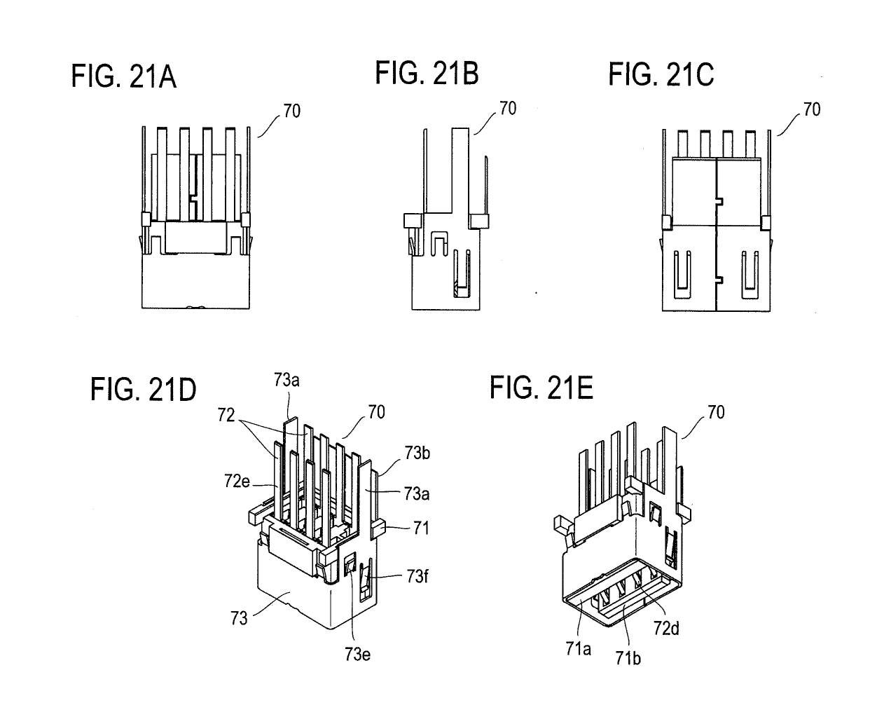

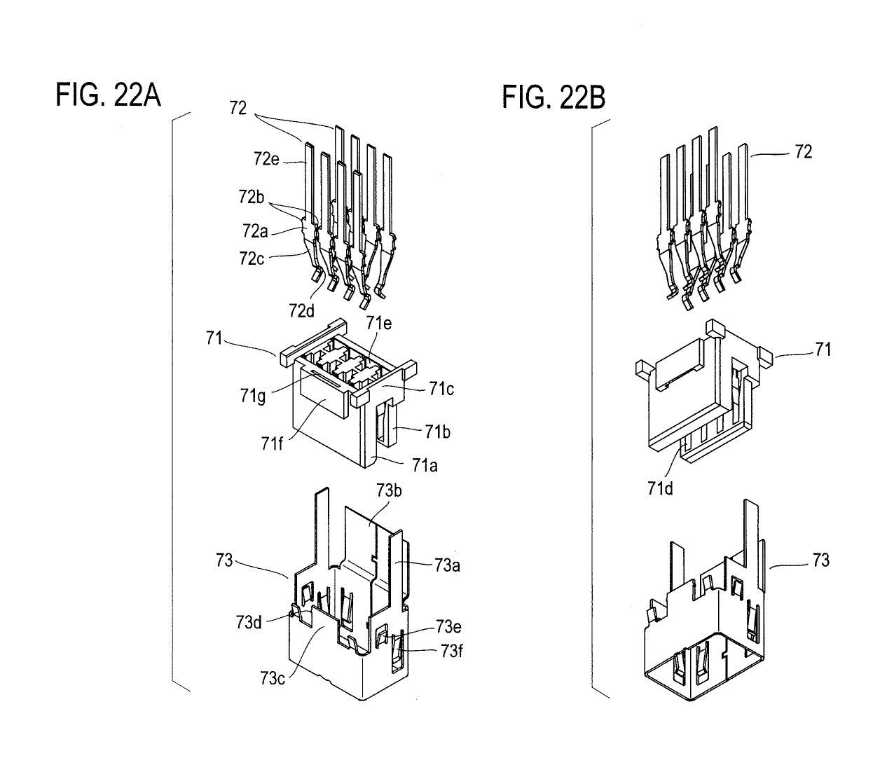

FIGS. 21A to 21E show details of the contact assembly 70 shown in FIGS. 20A and 20B. FIGS. 22A and 22B are exploded views of the contact assembly 70. The contact assembly 70 includes a body 71, relay contacts 72, and a shield shell 73.

The body 71 is made of resin and holds the relay contacts 72 in line. The body 71 includes a pair of vertical plates 71a and 71b, and their top ends are connected by a coupling member 71c. The vertical plates 71a and 71b respectively have four grooves 71d formed on their mutually opposing inner faces. The coupling member 71c has eight through holes 71e connected to the respective grooves 71d.

The relay contacts 72 are made of strip-shaped metal plates. A press-fitting part 72a in the middle in the longitudinal direction of each relay contact 72 has projections 72b to be press-fitted on both sides in the width direction. The relay contact 72 is bent and raised at one side of the press-fitting part 72a to make a movable section 72c, and a contact portion 72d is folded back at the tip of the movable section 72c.

Each relay contact 72 is attached to the body 71 by press-fitting the press-fitting part 72a into the hole 71e in the body 71, and the movable section 72c is placed in the groove 71d. A total of eight relay contacts 72 are attached to the body 71. An extended part 72e at the opposing end of the relay contact 72 sticks out from the body 71.

The shield shell 73 is formed by bending a metal plate and has a rectangular tube shape surrounding the body 71. Extended parts 73a extend upward from the opposing short sides of one end (upper end) of the shield shell 73, and an extended part 73b extends upward from one long side. On the other long side, a narrowed part 73c has projections 73d to be press-fitted on both sides in the width direction.

The shield shell 73 is secured to the body 71 by press-fitting the narrowed part 73c into a slit 71g formed in a projection portion 71f projecting from the outer face of the vertical plate 71a of the body 71. Like the extended parts 72e of the relay contacts 72, the extended parts 73a and 73b of the shield shell 73 stick out from the body 71. The contact assembly 70 is formed by press-fitting the eight relay contacts 72 and the shield shell 73 into the body 71.

The rear case 81 is made of metal, such as aluminum. The rear case 81 has a rectangular plate shape with a rectangular opening 81a formed at the center. A projection 81b is formed on the whole rim of the lower face, having a shape corresponding to the inner walls of the opening 65c of the case 65 in the second embodiment, described earlier.

The contact assembly 70 is press-fitted into the rectangular opening 81a of the rear case 81 from above. The shield shell 73 of the contact assembly 70 has fixing catches 73e. The shield shell 73 and the rear case 81 are secured to each other and are electrically connected by the catches 73e.

The insulating plate 83 has eight slits 83a corresponding to the eight relay contacts 72. The insulating plate 83 is mounted on the body 71 of the contact assembly 70 by passing the extended parts 72e of the relay contacts 72 through the slits 83a.

The housing 82 is similar to the housing 62 in the first embodiment in structure and includes a tubular part 82a, a flange 82b, and a side wall 82c. A window 82d is formed in the upper part of the side wall 82c. The lower end of the tubular part 82a is closed by a closing plate 82e, and a pair of vertical plates 82f and 82g stick out from the closing plate 82e.

Grooves 82h are formed on the outer faces of the vertical plates 82f and 82g in a direction parallel to the direction in which the vertical plates 82f and 82g stick out. Four grooves 82h are formed respectively on the vertical plates 82f and 82g. Slits 82i are formed on the closing plate 82e in line with the grooves 82h. The relay contacts 72 of the contact assembly 70 are inserted into the slits 82i. The closing plate 82e also has slits 82j and 82k into which the pair of extended parts 73a and the wide extended part 73b of the shield shell 73 of the contact assembly 70 are inserted.

The housing 82 structured as described above is bonded to the rear case 81 by the adhesive 84. Four bosses 82m projecting from the lower face of the flange 82b are inserted into through holes 81c formed in the rear case 81, and the ends are heat-caulked. The extended parts 72e of the eight relay contacts 72 of the contact assembly 70 pass through the slits 82i, project from the upper face of the closing plate 82e (inner bottom of the tubular part 82a), and reach the grooves 82h of the vertical plates 82f and 82g of the housing 82. The extended parts 73a and 73b of the shield shell 73 pass through the slits 82j and 82k and project from the inner bottom of the tubular part 82a of the housing 82.

The inside of the tubular part 82a is filled with resin, and the inner bottom of the tubular part 82a is sealed with the resin sealant 85. The relay connector 300 has the structure as described above. Engraved parts 82n are provided as shown in FIG. 19 at the bases of the vertical plates 82f and 82g in the areas where the relay contacts 72 are placed in order to improve the flow of the resin sealant 85 and to provide a proper waterproofing structure. The insulating plate 83 closes this area.

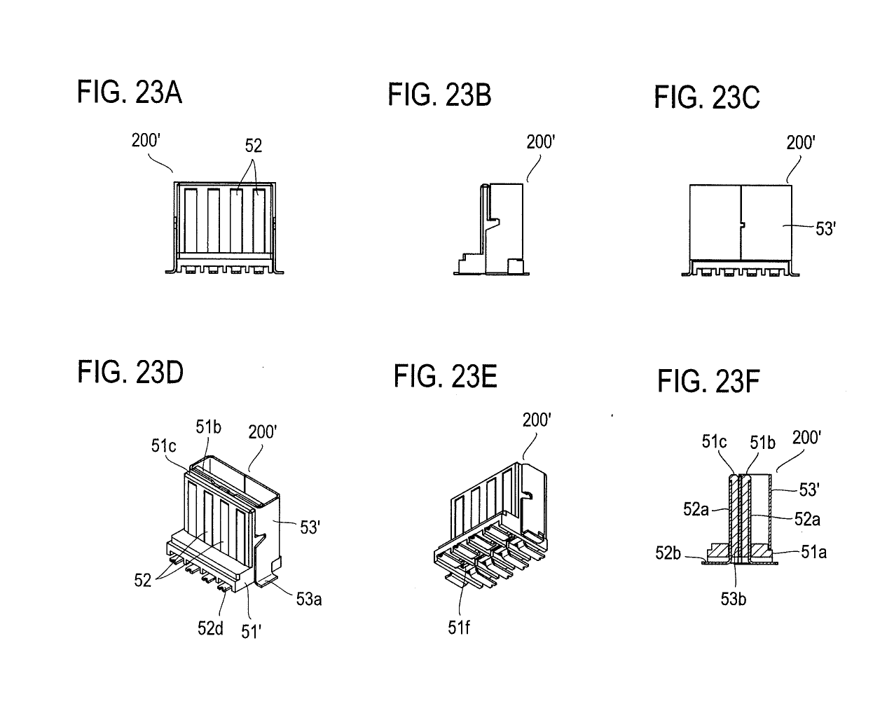

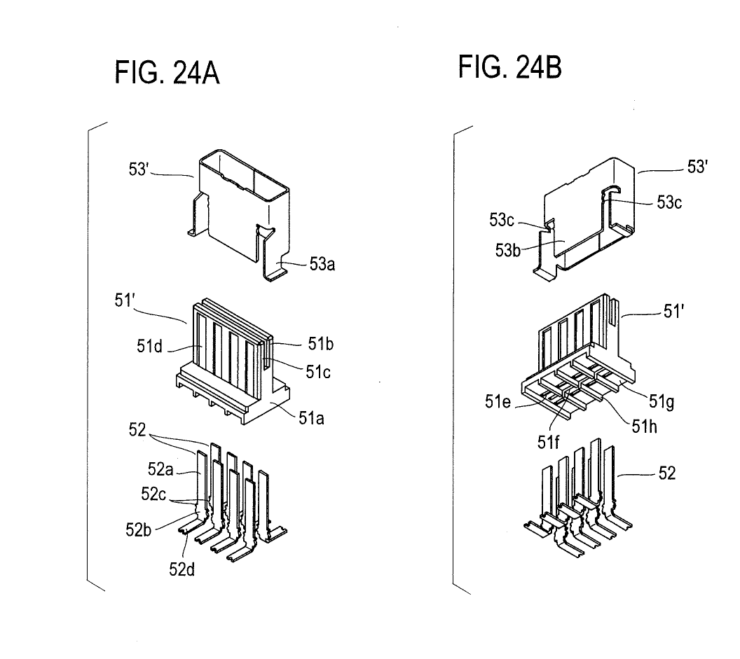

FIGS. 23A to 23F show the appearance of a board connector 200′ and a sectional view of its structure. FIGS. 24A and 24B are exploded views of the board connector 200′. Like the board connector 200 in the first embodiment, the board connector 200′ includes a body 51′, eight board contacts 52, and a shield shell 53′. The space between the pair of vertical plates 51b and 51c of the body 51′ is narrower than the space between the pair of vertical plates 51b and 51c of the body 51 in the first embodiment, and the length of the short side of the rectangular tube shape of the shield shell 53′ is smaller than that of the shield shell 53 in the first embodiment.

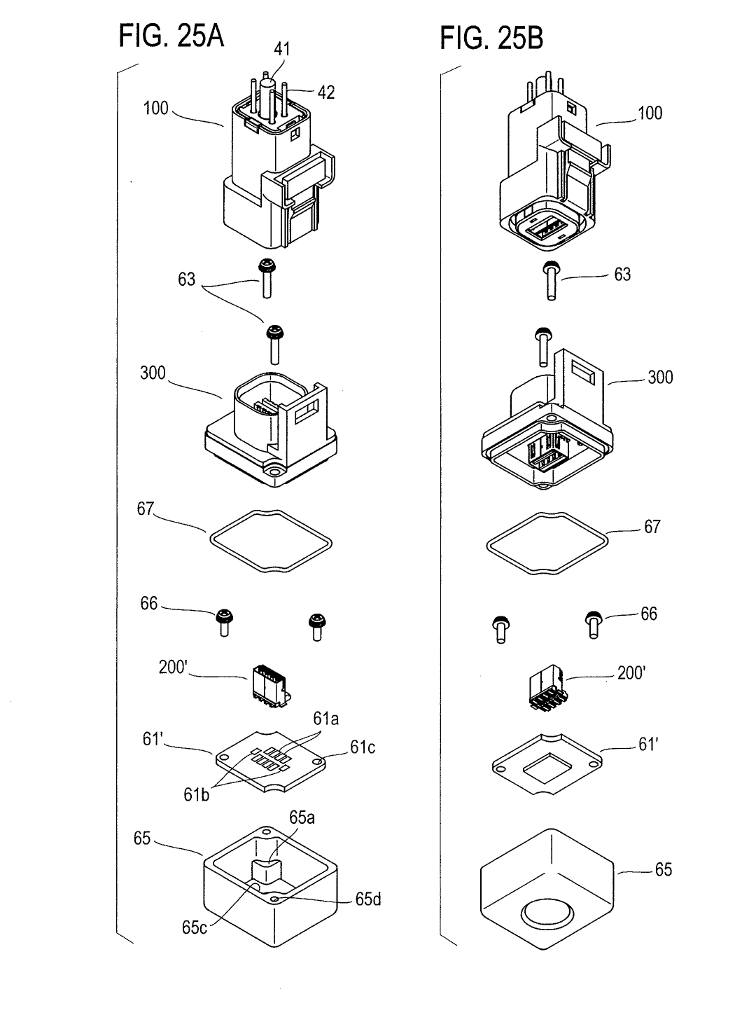

FIGS. 25A and 25B show the overall structure of the third embodiment. The board 61′, onto which the board connector 200′ is surface-mounted by reflow soldering, is secured to the case 65 by the screws 66, as in the second embodiment. The projection 81b on the lower face of the rear case 81 is inserted into the opening 65c of the case 65, and the relay connector 300 is mounted to the case 65 to close the opening 65c. The relay connector 300 is secured by using the two screws 63. The two screws 63 are inserted into the two holes 81d formed in the rear case 81 and are screwed into the holes 65d of the case 65 to secure the relay connector 300 onto the case 65. The O ring 67 is disposed around the projection 81b on the lower face of the rear case 81, and the O ring 67 is held between the upper face of the case 65 and the rear case 81.

By mounting the relay connector 300 as described above, the pair of vertical plates 51b and 51c and the shield shell 53′ of the board connector 200′ are inserted into the shield shell 73 of the contact assembly 70 of the relay connector 300. The board contacts 52 come into contact with the relay contacts 72, respectively, thus connecting the eight board contacts 52 and the eight relay contacts 72. The shield shell 53′ of the board connector 200′ and the shield shell 73 of the relay connector 300 are electrically connected by the contact pieces 73f cut and raised in the shield shell 73 held in contact with the shield shell 53′.

The cable connector 100 is connected to the relay connector 300. The insertion joint 21a of the cable connector 100 is inserted into and coupled to the tubular part 82a of the housing 82 of the relay connector 300, and the projection 21f of the cable connector is caught by the window 82d of the housing 82. The housing 82 guides the cable connector 100 and also prevents it from falling out.

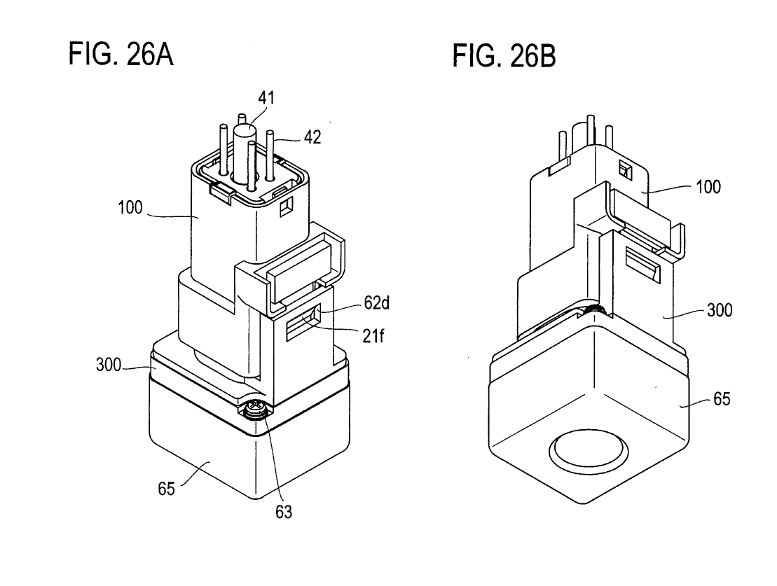

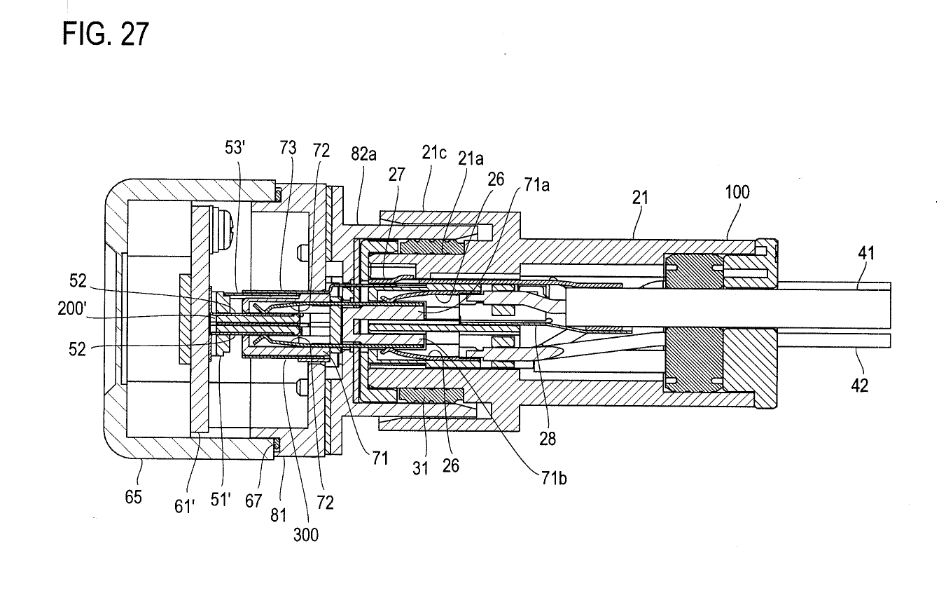

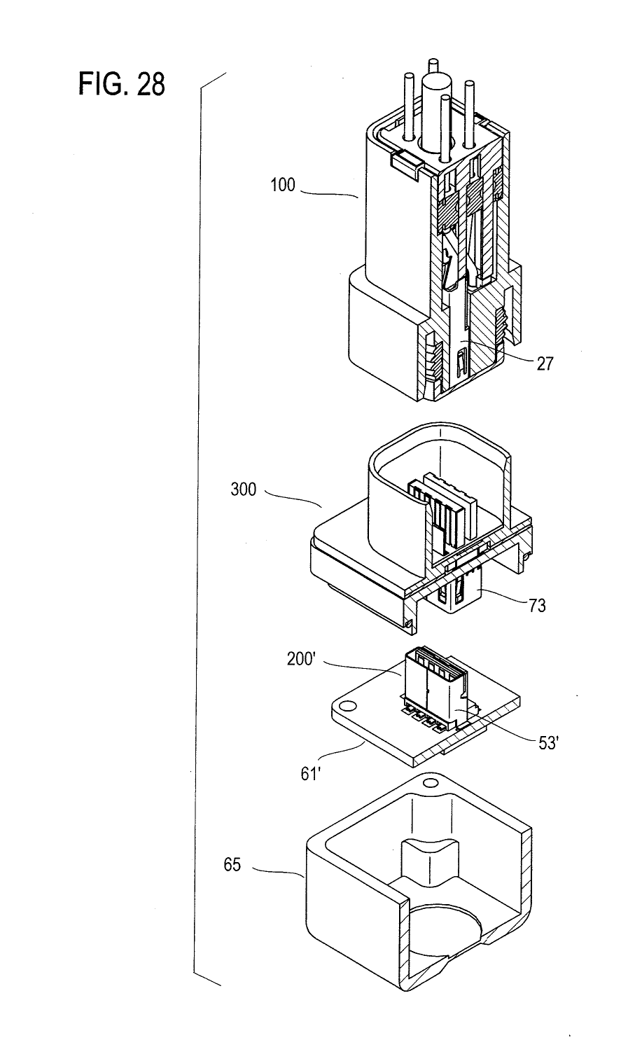

FIGS. 26A and 26B show states in which the cable connector 100 is connected to the relay connector 300 as described above, and FIG. 27 is a sectional view of the connection. FIG. 28 is the same kind of sectional view as shown in FIG. 12 in the first embodiment.

By connecting the cable connector 100 to the relay connector 300, the vertical plates 82f and 82g of the housing 82 of the relay connector 300 are inserted into the insertion joint 21a of the cable connector 100. The contact portions 26d of the eight contacts 26 of the cable connector 100 come into contact with the relay contacts 72 arranged in the vertical plates 82f and 82g, respectively, thus connecting the eight contacts 26 of the cable connector 100 and the eight relay contacts 72 of the relay connector 300. The extended parts 73a and 73b of the shield shell 73 of the relay connector 300 are inserted into the shield shell 30 of the cable connector 100, and the contact pieces 27d disposed in the shell 27, constituting the shield shell 30, come into contact with and are electrically connected to the extended parts 73a and 73b.

In this embodiment, the cable connector 100 and the board connector 200′ are connected through the relay connector 300. The contacts 26 of the cable connector 100 are connected to the board contacts 52 of the board connector 200′ through the relay contacts 72 of the relay connector 300.

In this embodiment, the relay connector 300 is mounted to the case 65 to close the opening 65c of the case 65. Since the inner bottom face of the tubular part 82a of the housing 82 of the relay connector 300 is sealed by the resin sealant 85, a waterproofing structure is implemented in a state in which the relay connector 300 is mounted to the case 65, preventing liquid from entering the case 65.

The shield shell 73 of the relay connector 300 does not have a structure that surrounds only the relay contacts 72 connected to the contacts 26 of the cable connector 100 which are connected to the core wires 41b of the shielded cable 41. However, in a state in which the board connector 200′, the relay connector 300, and the cable connector 100 are connected, the unsurrounded part is very small. When the connectors are connected, the impedance is substantially determined by the transfer path between the cable connector 100 and the board connector 200′.

In the embodiments described above, since the board connectors 200 and 200′ are surface-mounted, they can be mounted to a board, for example, together with the other electronic components by reflow soldering, which facilitates assembly.

A connector according to the present invention has a shielded transfer path and a non-shielded transfer path and is favorable for sending a control signal and an image signal in a camera, for example, as described in one embodiment. By sending the image signal in the shielded transfer path and the control signal in the non-shielded transfer path, the image signal can be isolated from noise occurring from the control signal and can be sent properly at high speed. An inexpensive non-shielded cable (discrete wire) is used for the control signal, which does not need to be shielded.

What is claimed is:

1. A connector comprising:
a board connector mounted on a board; and
a cable connector attached to ends of both a shielded cable and a non-shielded cable and connected to the board connector;
the cable connector comprising:
contacts connected respectively to core wires of the shielded cable and the non-shielded cable; and
a shield shell surrounding only the contacts connected to the core wires of the shielded cable;
the board connector comprising:
board contacts connected respectively to the contacts of the cable connector; and
a shield shell surrounding only the board contacts connected to the contacts surrounded by the shield shell.

2. A connector according to claim 1, further comprising a housing mounted on the board,
wherein the housing comprises:
a tubular part to which an insertion joint of the cable connector is coupled; and
a window which catches a projection on the cable connector; and
the housing guides the cable connector with respect to the board connector and prevents the cable connector from falling out.

3. A connector according to claim 1, further comprising a housing that is disposed at an opening of a case accommodating the board and that is mounted to the case,
wherein the housing comprises:
a tubular part to which an insertion joint of the cable connector is coupled; and
a window which catches a projection on the cable connector; and
the housing guides the cable connector with respect to the board connector and prevents the cable connector from falling out.

4. A connector according to claim 1, wherein the cable connector and the board connector are connected through a relay connector.

5. A connector according to claim 4,
wherein the relay connector comprises relay contacts, a rear case, and a housing;
the contacts and the board contacts are connected through the relay contacts;
the rear case is disposed at an the opening of a case accommodating the board and is mounted to the case; and
the housing comprises a tubular part to which the insertion joint of the cable connector is coupled and a window which catches a projection on the cable connector and is secured onto the rear case.

6. A connector according to claim 5,
wherein the relay contacts project from the inner bottom of the tubular part, and
the inner bottom of the tubular part is sealed with resin.

7. A connector according to claim 2, wherein the back end of the cable connector from which the shielded cable and the non-shielded cable are led out and the insertion joint are surrounded by respective waterproofing members.

8. A connector according to claim 3, wherein the back end of the cable connector from which the shielded cable and the non-shielded cable are led out and the insertion joint are surrounded by respective waterproofing members.

9. A connector according to claim 5, wherein the back end of the cable connector from which the shielded cable and the non-shielded cable are led out and the insertion joint are surrounded by respective waterproofing members.

10. A connector according to claim 6, wherein the back end of the cable connector from which the shielded cable and the non-shielded cable are led out and the insertion joint are surrounded by respective waterproofing members.

11. A connector according to one of claims 1 to 10, wherein the board connector is surface-mounted on the board.
